(19) United States
(12) Patent Application Publication
(10) Pub. No.: US 2010/0304709 A1
(43) Pub. Date: Dec. 2, 2010

(54) DEVICE, METHOD, AND SYSTEM FOR OBTAINING EMERGENCY HELP

(75) Inventors: Curtis Riley, Nashville, TN (US); Robert Robinson, Goodlettsville, TN (US)

Correspondence Address: STITES & HARBISON, PLLC, 400 W MARKET ST, SUITE 1800, LOUISVILLE, KY, 40202-3352, US

(73) Assignee: Safe Watch By Monsignor, LLC

(21) Appl. No.: 12/789,252

(22) Filed: May 27, 2010

Related U.S. Application Data
(60) Provisional application No. 61/217,066, filed on May 27, 2009.

(51) Int. Cl. H04M 11/04

(52) U.S. Cl. 455/404.2; 455/404.1

(57) ABSTRACT

Devices, methods, and systems for obtaining emergency help are provided that allow a user to obtain emergency help regardless of the user's location. The device includes a microphone, a speaker, a cellular communication antenna, a cellular communication module, a SOS pushbutton switch, and a microcontroller that are integrated into a single, wearable case. The methods for obtaining emergency help include the steps of detecting the actuation of the pushbutton and causing the cellular communication module to establish communication with an emergency call center via a commercial cellular communication network. The system for obtaining emergency help includes a cellular communication network, an emergency call center, and the device. The devices, methods, and systems also make use of a global positioning system (GPS) antenna and module to allow the location of the device, and the person wearing the device, to be determined.

### CROSS-REFERENCE TO RELATED APPLICATIONS

This application claims the benefit of U.S. Provisional Patent Application No. 61/217,066, filed May 27, 2009, the entire disclosure of which is incorporated herein by reference.

### TECHNICAL FIELD

The present invention relates to devices, methods, and systems for obtaining emergency help. More specifically, the present invention relates to devices, methods, and systems for obtaining emergency help that make use of a cellular communication module, a SOS pushbutton switch, and a microcontroller, that are integrated into a single, wearable case and allow a user to obtain emergency help regardless of the user's location.

### BACKGROUND OF THE INVENTION

As the age of an individual increases, changes in the individual's mental or physical health can have a significant impact on that individual's ability to live independently. Indeed, as individuals grow older, it becomes increasingly likely that an emergency situation will arise in which that individual will require emergency help or medical attention. In certain instances, however, it may be the case that the individual will be unable to reach a telephone to call for help. For example, in the case of a severe fall or a stroke, heart attack or other serious condition or illness, an individual, such as a senior, may lay on a floor for hours or days, disconnected from needed assistance, as the individual does not have the ability to reach the telephone and call for help.

To address such situations, numerous call devices or devices for obtaining emergency help have been developed to not only allow individuals to obtain emergency assistance, but to also provide these individuals with peace of mind and allow them to continue to live independently. To date, however, the available devices generally make use of a base unit, which includes a microphone and a speaker, and a wearable unit that includes a pushbutton. In the event of an emergency, an individual simply pushes the button on their wearable unit to activate the base unit, which is generally stationed in a particular location in the individual's home. Once the base unit is activated, the individual can then communicate with an emergency operator through the microphone and speaker of the base unit such that the emergency operator can assess the situation and then contact the individual's neighbor or family member, or can contact an emergency responder, as needed.

Current devices for obtaining emergency help have provided many individuals, such as seniors, with assistance in a number of emergency situations and have provided them with a sense of security that, in turn, improves their quality of life. However, many problems still persist with these devices that limit their usefulness. For example, if the user is out of speaking range of the base unit, the user will not be able to effectively speak to or hear the emergency operator. Furthermore, if a user is not in close enough proximity to the base unit, the wearable pushbutton device may be outside of its working range (which is normally less than 200 feet from the base unit) such that the push button device is not able to communicate with the base unit. In such situations, it is likely that the base unit will never be activated and no one will be made aware of the user's emergency situation.

In any event, a device, system, and method for obtaining emergency help has yet to be designed that is comprised of a single, wearable unit that, in the event of an emergency, allows a user to speak to an emergency operator regardless of the user's location.

### BRIEF SUMMARY OF THE INVENTION

The present invention is a device, method, and system for obtaining emergency help that allows a user to obtain emergency help regardless of the user's location (as long as the user is within a coverage area of a commercial cellular communication network).

In some embodiments of the invention, a device for obtaining emergency help is provided that includes a microphone, a speaker, a cellular communication antenna, a cellular communication module, a SOS pushbutton switch, and a microcontroller that are integrated into a single, wearable case. The cellular communication module is operably connected to the microphone, the speaker, and the cellular communication antenna such that the cellular communication module is capable of providing communication between the microphone, the speaker, and a commercial cellular communication network in the event of an emergency. In this regard, the microcontroller is operably connected to the cellular communication module and the SOS pushbutton switch such that, in response to an actuation of the pushbutton switch, the microcontroller causes the cellular communication module to establish communication with an emergency operator via the commercial cellular communication network.

In some embodiments of the presently-disclosed device, the device further comprises a display device and a touch screen that are operatively connected to the microcontroller such that the microcontroller causes the display device to display indicia in response to detecting the actuation of the pushbutton, and only causes the cellular communication module to establish communication with the emergency operator after actuation of the touch screen. In other embodiments, a device for obtaining emergency help is provided that further comprises a global positioning system (GPS) antenna and module, where the GPS module can receive GPS signals, determine the location of the device, and transmit the location of the device to the cellular communication module and, ultimately, the emergency operator. In some embodiments, the cellular communication module is capable of receiving a request to obtain the location of the device from the emergency operator such that the emergency operator can request and obtain the location of the device.

Further provided, in some embodiments of the present invention, are methods for obtaining emergency help. In one embodiment, a method is provided that includes detecting, by a microcontroller of a device for obtaining emergency help of the present invention, an actuation of a SOS pushbutton switch of the device; and causing a cellular communication module of the device to establish communication with an emergency call center via a commercial cellular communication network.

Still further provided, in some embodiments of the present invention, are systems for obtaining emergency help. In some embodiments, a system for obtaining emergency help is provided that includes: a commercial cellular communication network; an emergency call center in communication with the commercial cellular communication network; and a communication device of the present invention.

Other features and advantages of the invention will be set forth in, or apparent from, the detailed description of preferred embodiments of the invention found below.

### BRIEF DESCRIPTION OF THE DRAWINGS

FIG. 1 is a functional block diagram of an exemplary device for obtaining emergency help according to the invention.

FIG. 2 is a block diagram of an exemplary system for obtaining emergency help according to the invention.

FIG. 3 is a flow chart of an exemplary method for obtaining emergency help according to the invention.

FIG. 4 is a front elevational view of an exemplary embodiment of a user wearable watch in accordance with the block diagram of the device of FIG. 1.

FIG. 5 is another front elevational view of the user wearable watch of FIG. 4.

FIG. 6 is a rear elevational view of the user wearable watch of FIG. 4.

FIG. 7 is a top plan view of the user wearable watch of FIG. 4.

FIG. 8 is a bottom plan view of the user wearable watch of FIG. 4.

FIG. 9 is a left side elevational view of the user wearable watch of FIG. 4.

FIG. 10 is a right side elevational view of the user wearable watch of FIG. 4.

FIG. 11 is a perspective view of the user wearable watch of FIG. 4.

### DESCRIPTION OF EXEMPLARY EMBODIMENTS OF THE INVENTION

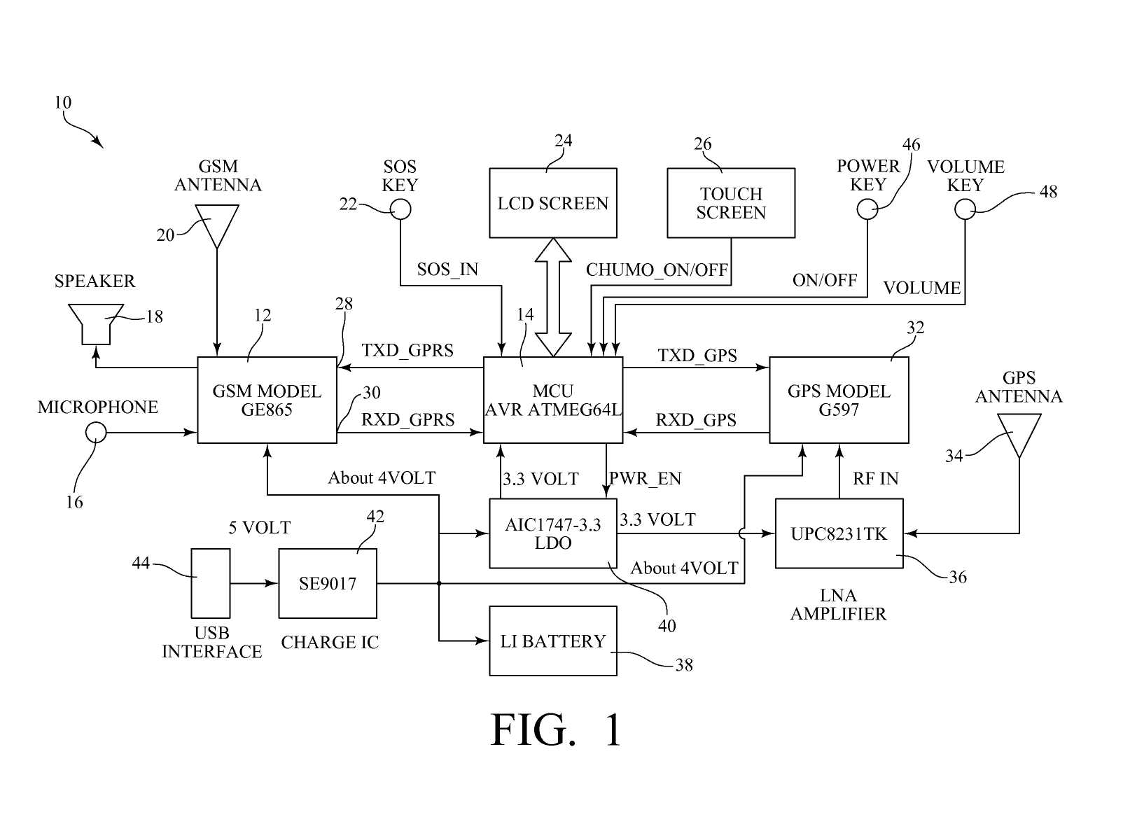

FIG. 1 is a functional block diagram of an exemplary device 10 for obtaining emergency help according to an embodiment of the invention. As shown, the exemplary device 10 includes a cellular communication module 12 and a microcontroller 14. Also shown are a microphone 16, a speaker 18, a cellular communication antenna 20, a SOS pushbutton switch 22, a display device 24, and a touchscreen 26.

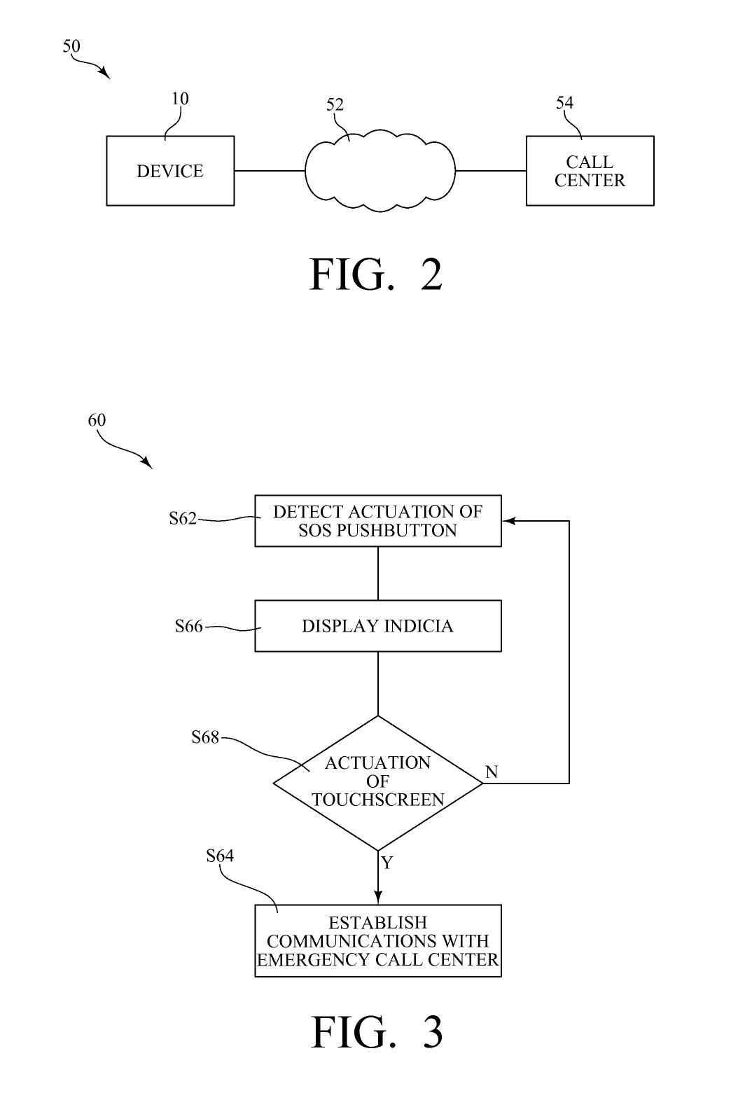

The cellular communication module 12 is operably connected to the microphone 16, the speaker 18, and the cellular communication antenna 20. The cellular communication module 12 provides communication between the microphone 16, the speaker 18, and a commercial cellular communication network 52 (FIG. 2). The cellular communication module 12 also has a serial data input (TXD) 28 and a serial data output (RXD) 30 for communicating with data terminal equipment (DTE). In a preferred embodiment, a model GE865GSM/GPRS, manufactured by Telit Communications S.p.A., of Trieste, Italy is utilized as the cellular communication module 12. Advantageously, the cellular communication module 12 of the preferred embodiment includes an idle, power saving mode wherein only approximately 1.6 milliamps of power are consumed, compared with a maximum power usage of approximately 475 milliamps of power.

The microcontroller 14 is operably connected to the cellular communication module 12 and the SOS pushbutton switch 22. Upon detecting an actuation of the SOS pushbutton switch 22, the microcontroller 14 causes the cellular communication module 12 to establish communications with an emergency operator at an emergency call center 54 (FIG. 2) via the commercial cellular communication network 52 (FIG. 2). In a preferred embodiment, a model ATmega64L microcontroller, manufactured by ATMEL Corporation of San Jose, Calif. is used as the microcontroller 14. The emergency operator will speak to the user through the exemplary device 10, and will then connect the user to a person from a predetermined call list or to emergency services, if necessary.

Advantageously, the cellular communication module 12, the microcontroller 14, the microphone 16, the speaker 18, the cellular communication antenna 20, and the SOS pushbutton switch 22 are integrated into a single, wearable case that may resemble a watch, a pendant, or the like. The device 10 is wearable, so that the device will not be easily lost or stolen (such as a cell phone carried in a purse or the like may be lost or snatched). Further, the single button call is beneficial for seniors or children who may be unable to compete a call if more complex dialing were required on the device, or in situations where the user has been injured.

With regard to the display device 24, and referring still to FIG. 1, the display device 24 is operably connected to the microcontroller 14. In a preferred embodiment, the display device 24 is an LCD screen such that, in some embodiments, the microcontroller 14 causes the display device 24 to display the time of day and allow the exemplary device 10 to function as a watch, as described in further detail below.

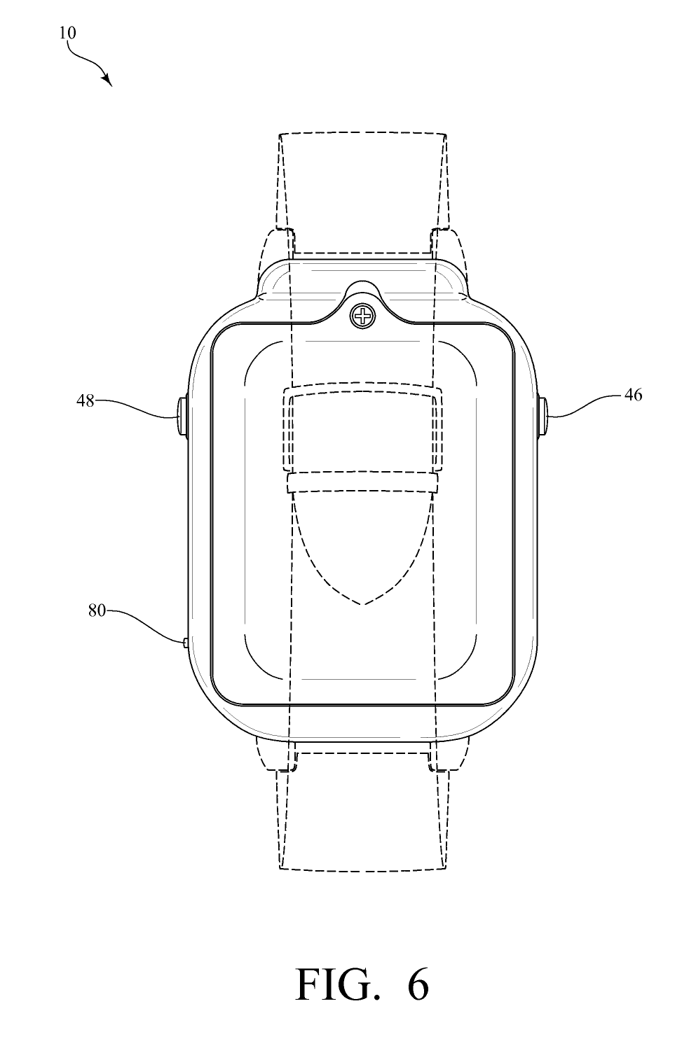

In some embodiments, the touchscreen 26 is also operatively connected to the microcontroller 14 and overlays the display device 24. In these embodiments, the microcontroller 14 is further for causing the display device 24 to display indicia, such as a solid circle or box (FIG. 5), in response to detecting the actuation of the SOS pushbutton switch 22. Then, to implement a two-step process to reduce the incidence of false communication with the emergency operator, the microcontroller 14 will only cause the cellular communication module 12 to establish communication with the emergency operator after detecting actuation of the touchscreen 26.

In certain embodiments, the exemplary device 10 also includes a global positioning system (GPS) module 32 operably connected to a GPS antenna 34 and the microcontroller 14. Preferably, the GPS antenna 34 is connected to the GPS module 32 via an amplifier 36, so that a small antenna can be utilized. The GPS module 32 is for receiving GPS signals, determining a location of the exemplary device 10 and communicating the location of the exemplary device 10 to the microcontroller 14. In these embodiments, the microcontroller 14 is further for communicating the location of the device 10 to the cellular communication module 12, and the cellular communication module 12 is further for transmitting the location of the device 10 to the emergency operator.

Additionally, the cellular communication module 12 of the exemplary device 10 is further for receiving a request to obtain the location of the device 10 from the emergency operator, and communicating the request to obtain the location of the device 10 to the microcontroller 14. In this case, the microcontroller 14 is further for requesting the location of the device 10 from the GPS module 32. Then, the GPS module 32 is for receiving GPS signals via the GPS antenna 34, determining a location of the device 10 and communicating the location of the device 10 to the microcontroller 14, which then communicates the location of the device 10 to the cellular communication module 12. The cellular communication module 12 subsequently transmits the location of the device 10 to the emergency operator. Thus, the emergency operator can initiate a request and receive the location of the exemplary device 10 without the SOS pushbutton switch 22 being actuated. As will be recognized by those skilled in the art, such a function is particularly useful in the event that the person wearing the exemplary device 10 becomes lost and is unable or forgets to actuate the pushbutton switch 22.

The microcontroller 14 may further power down the GPS module 32 when the location of the device 10 is not required, in order to conserve power, and power up the GPS module 32 when the location of the device 10 is required.

The power system of the device 10 also typically includes a battery 38, such as a lithium ion battery, that is operably connected to the cellular communication module 12, microcontroller 14, the GPS module 32, and the amplifier 36. As shown in FIG. 1, the microcontroller 14 and the amplifier 36 can be connected to the battery 38 through a voltage regulator 40. In some embodiments, the exemplary device 10 can further include a charging circuit 42 that receives power through a USB interface 44.

Lastly, the exemplary device 10 can further include a power key 46 and a volume key 48 operably connected to the microcontroller 14 for, respectively, powering the device 10 on/off and controlling a volume of the speaker 18.

Referring now to FIG. 2, an exemplary system 50 for obtaining emergency help includes a commercial cellular communication network 52, an emergency call center 54 in communication with the commercial cellular communication network 52, and a device 10 for communicating with the call center 54 via the commercial cellular communication network 52. Advantageously, the exemplary system 50 utilizes the exemplary device 10 for obtaining emergency help described herein above. Thus, help is available wherever the user is located, and the user's wearable device can report the user's exact location to the emergency operator. Additionally, the emergency operator can then communicate with the user and determine the most appropriate person to respond, whether that be a family member, a neighbor, or an emergency responder such as a police officer, a firefighter, or an emergency medical provider.

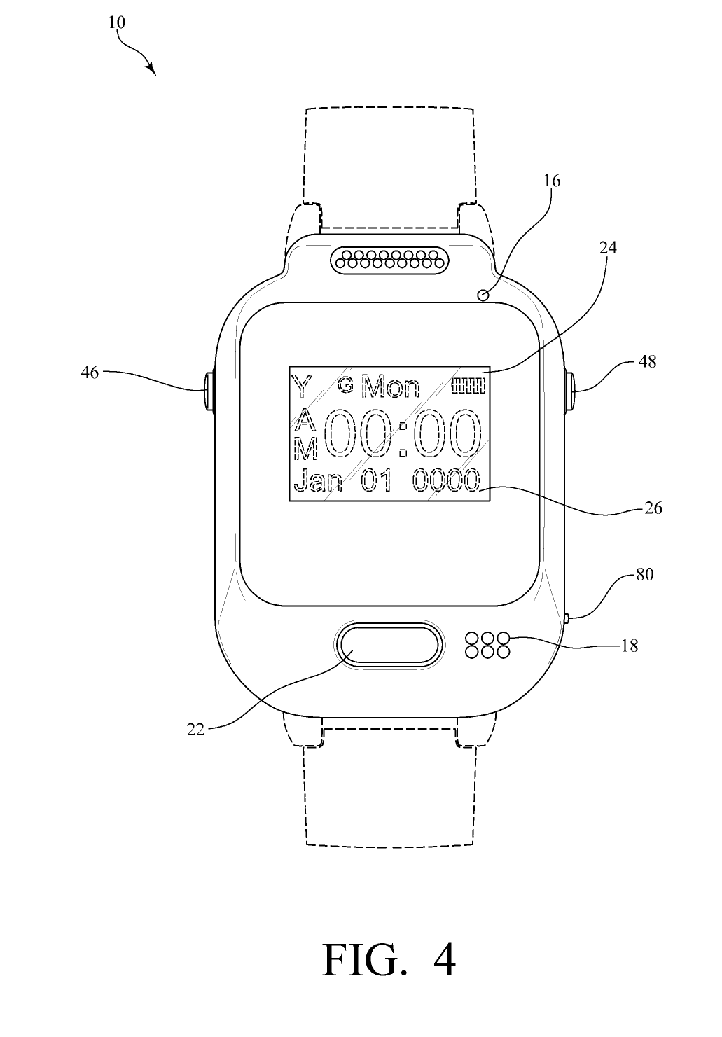

Turning now to FIG. 3, FIG. 3 is a flowchart of an exemplary method 60 for obtaining emergency help according to the invention. A first step S62 is detecting, by the microcontroller 14, an actuation of the SOS pushbutton switch 22 of the device 10. The next step S64 is causing the cellular communication module 12 to establish communications with the emergency call center 54 via the commercial cellular communication network 52. In order to reduce incidents of false communication with the emergency call center, in some embodiments, the exemplary method 60 further includes a step S66 of causing the display device 24 to display indicia in response to the step S62 of detecting the actuation of the SOS pushbutton switch. Then, a step S68 of detecting actuation of the touchscreen 26 overlaying the display device 24 can be performed before the step S64 of establishing communication with the emergency call center 54. If, the touchscreen 26 is not actuated, then communications will not be established with the emergency call center 54.

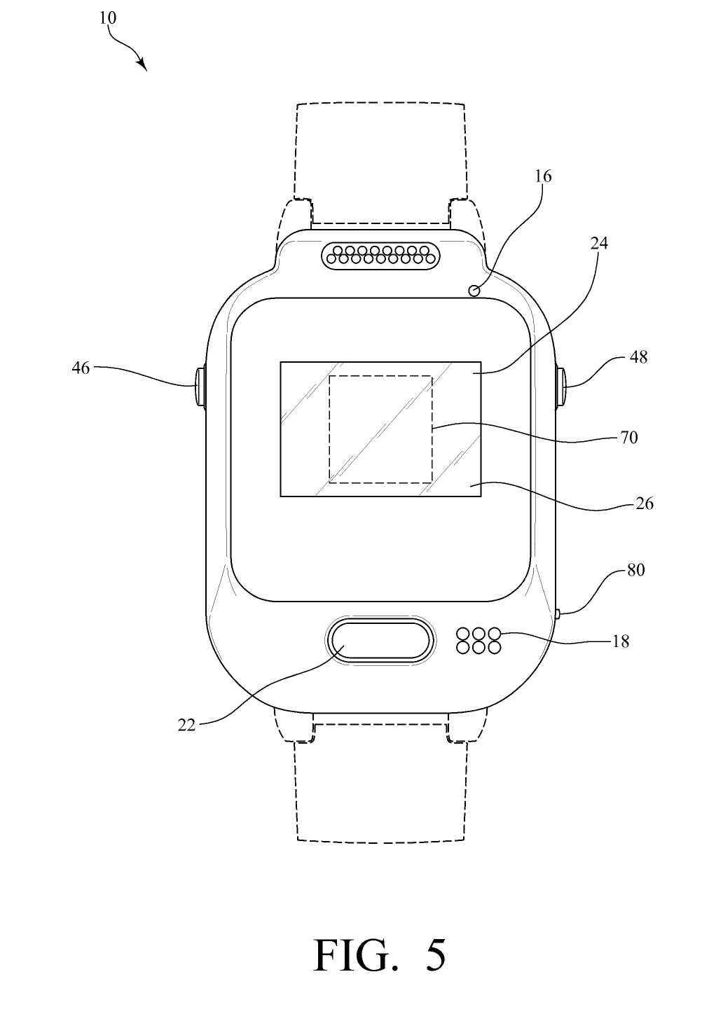

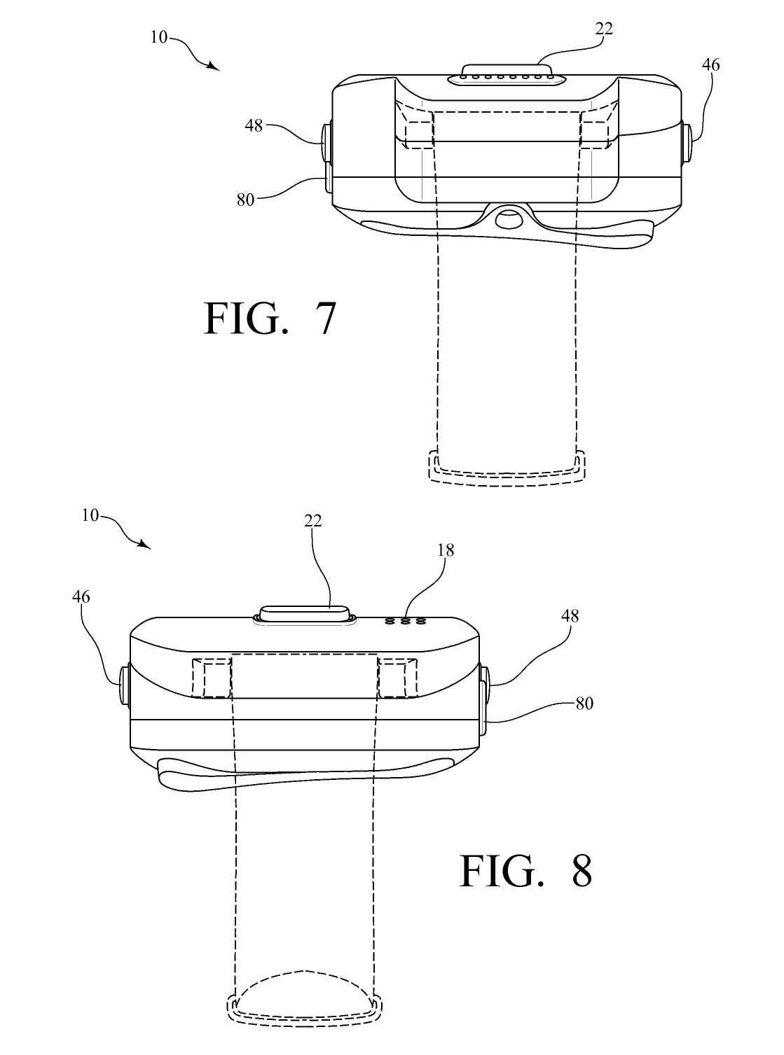

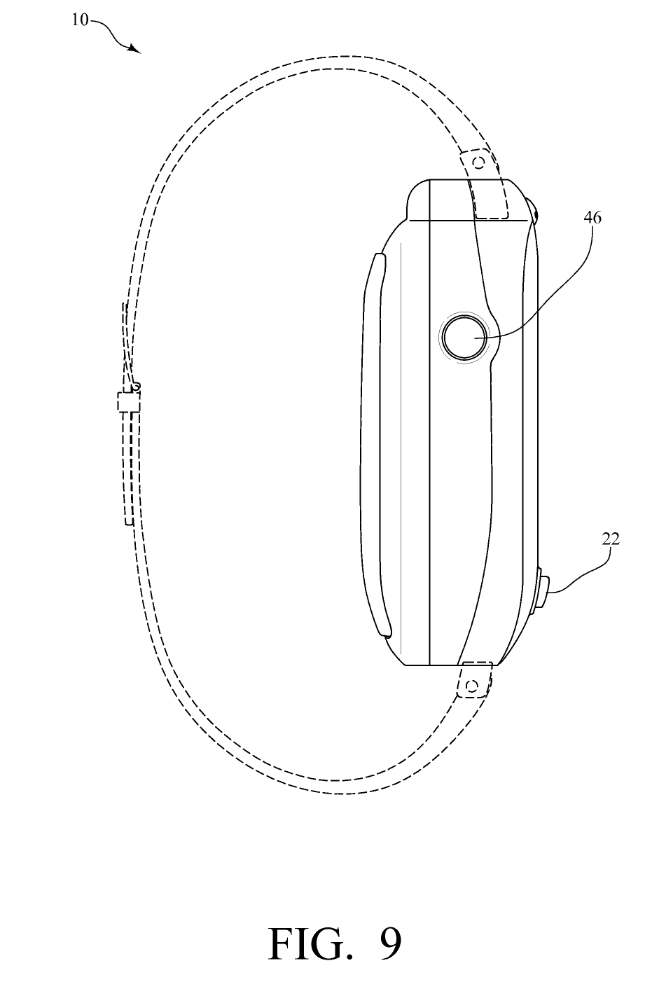

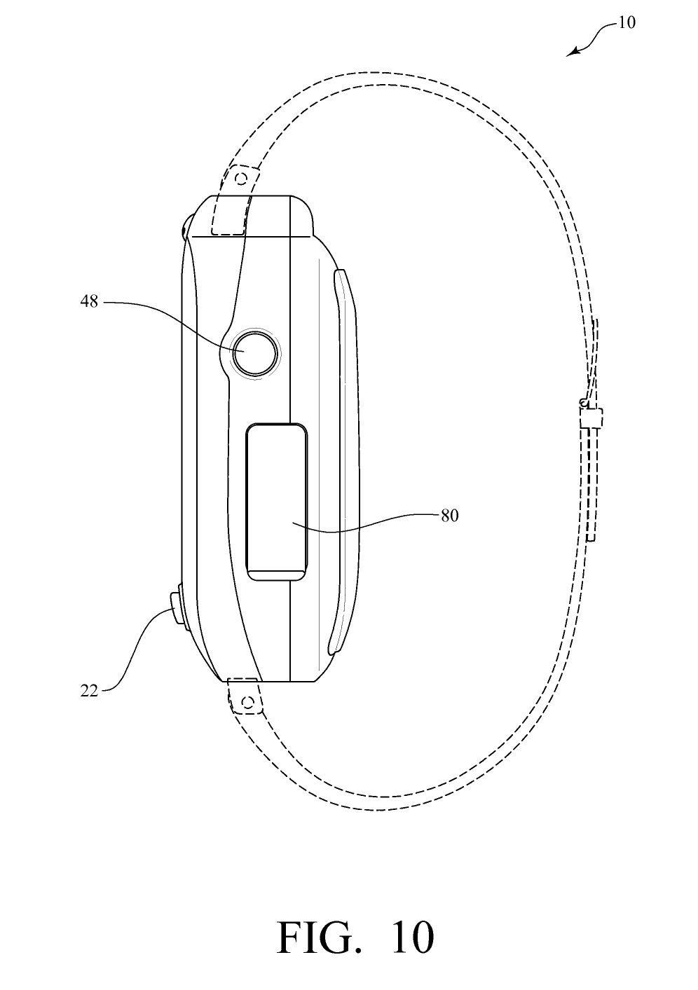

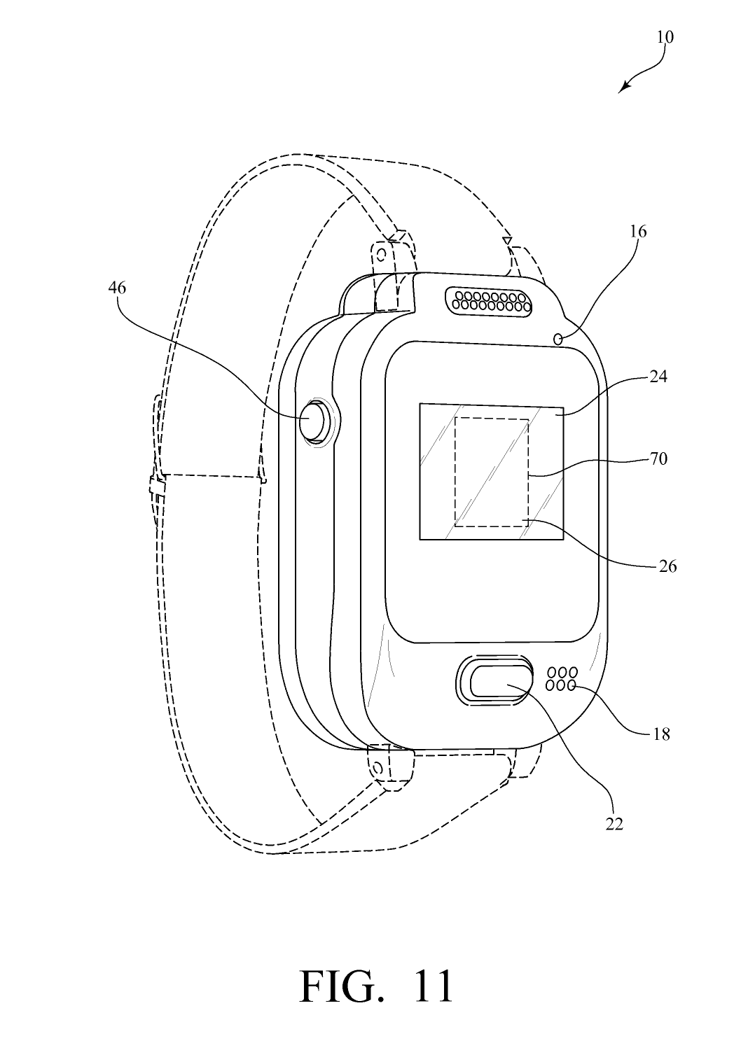

As noted above, a device 10 of the present invention can be manufactured in the form of a wearable article, such as a watch, pendant, or the like, that is not easily lost or stolen. In one exemplary embodiment of the device 10, and as shown in FIGS. 4-11, the device 10 is in the form of a user wearable watch that includes the microphone 16, the speaker 18, the display device 24, the touchscreen 26 overlaying the display device 24, the SOS pushbutton switch 22, the power key 46, and the volume key 48. As also noted above, and as shown in FIG. 5, an indicia 70, such as a circle or a box on the display device 24 can be included to prompt the user to actuate the touchscreen 26 prior to establishing communication with the emergency call center 54 (FIG. 2). Furthermore, and as perhaps best shown in FIG. 10, the device 10 can include a USB port that is protected by a cover 80 such that upon removal of the cover 80, the device 10 can be attached to a charging station or the like through a USB interface and receive an electrical current to power the device 10 and/or charge the battery 38 (FIG. 1).

One of ordinary skill in the art will recognize that additional configurations and steps are possible without departing from the teachings of the invention. This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

Thus, the scope of the invention should be determined by the appended claims and their legal equivalents, and not by the examples given.

What is claimed is:

1. A device for obtaining emergency help, comprising:
a microphone;
a speaker;
a cellular communication antenna;
a cellular communication module operably connected to the microphone, the speaker and the cellular communication antenna, the cellular communication module for providing communication between the microphone, the speaker, and a commercial cellular communication network;
a SOS pushbutton switch; and
a microcontroller operably connected to the cellular communication module and the SOS pushbutton switch, the microcontroller for causing, in response to detecting an actuation of the SOS pushbutton switch, the cellular communication module to establish communication with an emergency operator via the commercial cellular communication network;
the microphone, the speaker, the cellular communication antenna, the cellular communication module, the SOS pushbutton switch, and the microcontroller integrated into a single, wearable case.

2. The device of claim 1, further comprising a display device operably connected to the microcontroller, the microcontroller further for causing the display device to display a time of day.

3. The device of claim 1, further comprising a display device and a touch screen operatively connected to the microcontroller, the touch screen overlaying the display device, wherein the microcontroller is further for causing the display device to display indicia in response to detecting the actuation of the SOS pushbutton switch, and only causing the cellular communication module to establish communication with the emergency operator after detecting actuation of the touch screen, so as to reduce incidents of false communication with the emergency operator.

4. The device of claim 1, further comprising:
a global positioning system (GPS) antenna; and
a GPS module operably connected to the GPS antenna and the microcontroller, the GPS module for receiving GPS signals, determining a location of the device, and communicating the location of the device to the microcontroller;
the microcontroller further for communicating the location of the device to the cellular communication module;
the cellular communication module further for transmitting the location of the device to the emergency operator.

5. The device of claim 1, further comprising:
a GPS antenna; and
a GPS module operably connected to the GPS antenna and the microcontroller;
the cellular communication module further for receiving a request to obtain a location of the device from the emergency operator and communicating the request to obtain the location of the device to the microcontroller;
the microcontroller further for requesting the location of the device from the GPS module;
the GPS module for receiving GPS signals, determining the location of the device, and communicating the location of the device to the microcontroller;
the microcontroller further for communicating the location of the device to the cellular communication module;
the cellular communication module further for transmitting the location of the device to the emergency operator.

6. A method for obtaining emergency help, comprising:
detecting, by a microcontroller of a device for obtaining emergency help, an actuation of an SOS pushbutton switch of the device; and
causing a cellular communication module of the device to establish communication with an emergency call center via a commercial cellular communication network,
the device further including a microphone and a speaker for the communication with the emergency operator;
the microcontroller, the SOS pushbutton switch, the cellular communication module, the microphone, and the speaker of the device being integrated into a single, wearable case.

7. The method of claim 6, further comprising:
causing a display device to display indicia in response to detecting the actuation of the SOS pushbutton switch; and
only causing the cellular communication module to establish communication with the emergency operator after detecting actuation of a touch screen, so as to reduce incidents of false communication with the emergency call center.

8. The method of claim 6, further comprising:
receiving a location of the device from a GPS module of the device; and
communicating the location of the device to the emergency operator via the cellular communication module of the device.

9. The method of claim 6, further comprising:
receiving a request to obtain a location of the device from the emergency operator via the cellular communication module of the device;
requesting the location of the device from a GPS module of the device;
receiving the location of the device from the GPS module of the device; and
communicating the location of the device to the emergency operator via the cellular communication module of the device.

10. A system for obtaining emergency help, comprising:
a commercial cellular communication network;
an emergency call center in communication with the commercial cellular communication network; and
a communication device comprising:
a microphone;
a speaker;
a cellular communication antenna;
a cellular communication module operably connected to the microphone, the speaker and the cellular communication antenna, the cellular communication module for providing communication between the microphone, the speaker, and the commercial cellular communication network;
a SOS pushbutton switch; and
a microcontroller operably connected to the cellular communication module and the SOS pushbutton switch, the microcontroller for causing, in response to detecting an actuation of the SOS pushbutton switch, the cellular communication module to establish communication with an emergency operator at the emergency call center via the commercial cellular communication network;
the microphone, the speaker, the cellular communication antenna, the cellular communication module, the SOS pushbutton switch, and the microcontroller integrated into a single, wearable case.

11. The system of claim 10, wherein the communication device further comprises a display device displaying a time of day.

12. The system of claim 10, wherein the communication device further comprises a display device and a touch screen overlaying the display device, wherein the microcontroller is further for causing the display device to display indicia in response to detecting the actuation of the SOS pushbutton switch, and only causing the cellular communication module to establish communication with the emergency operator after detecting actuation of the touch screen, so as to reduce incidents of false communication with the emergency operator.

13. The system of claim 10, wherein the communication device further comprises:
a global positioning system (GPS) antenna; and
a GPS module operably connected to the GPS antenna and the microcontroller, the GPS module for receiving GPS signals, determining a location of the communication device, and communicating the location of the communication device to the microcontroller;
the microcontroller further for communicating the location of the communication device to the cellular communication module;
the cellular communication module further for transmitting the location of the communication device to the emergency operator.

14. The system of claim 10, wherein the communication device further comprises:
a GPS antenna; and
a GPS module operably connected to the GPS antenna and the microcontroller;
the cellular communication module further for receiving a request to obtain a location of the communication device from the emergency operator and communicating the request to obtain the location of the communication device to the microcontroller;
the microcontroller further for requesting the location of the communication device from the GPS module;
the GPS module for receiving GPS signals, determining the location of the communication device, and communicating the location of the communication device to the microcontroller;
the microcontroller further for communicating the location of the communication device to the cellular communication module;
the cellular communication module further for transmitting the location of the communication device to the emergency operator.
